(19) United States
(12) Patent Application Publication
(10) Pub. No.: US 2015/0172358 A1
(43) Pub. Date: Jun. 18, 2015

(54) IMAGE UPLOADING METHOD, SYSTEM AND CLIENT

(71) Applicant: TENCENT TECHNOLOGY (SHENZHEN) COMPANY LIMITED, Shenzhen City (CN)

(72) Inventors: Yuan Huang, Shenzhen City (CN); Yongjian Wu, Shenzhen City (CN); Feiyue Huang, Shenzhen City (CN)

(21) Appl. No.: 14/626,671

(22) Filed: Feb. 19, 2015

Related U.S. Application Data
(63) Continuation of application No. PCT/CN2013/082133, filed on Aug. 23, 2013.

(30) Foreign Application Priority Data
Aug. 24, 2012 (CN) 201210305456.X

(51) Int. Cl. H04L 29/08; G06F 17/30

(52) U.S. Cl. CPC H04L 67/02; G06F 17/30873

(57) ABSTRACT

The present invention relates to an image uploading method, system and client, the image uploading method comprising the following steps: acquiring an image uploading request; labeling the sequence information of images; creating multiple threads according to the uploading request and the sequence information; and concurrently uploading the images according to the multiple threads created. The image uploading method, system and client employ a multi-thread concurrent image uploading mode to upload a plurality of images simultaneously, and can start uploading of a second image before the uploading of a first image is completed, thus improving network resource utilization rate, and saving overall time.

### CROSS-REFERENCE TO RELATED APPLICATIONS

This application is a U.S. continuation application of International Application No. PCT/CN2013/082133, filed Aug. 23, 2013, which itself claims the priority to and the benefit of Chinese Patent Application No. 201210305456.X, filed Aug. 24, 2012, which are incorporated herein in their entireties by reference.

### FIELD OF THE INVENTION

The present disclosure relates to network technologies, and more particularly relates to an image uploading method, system and client.

### BACKGROUND OF THE INVENTION

With the development of Internet technology, more and more people start to use the Internet, and surfing the Internet has become a part of people's lives. In the Internet, people can communicate over long distance and share interesting logs. Not satisfied with this, people further desire to place images, such as shooting scenery or person, on the Internet for other users to enjoy. Accordingly, an album service is provided on the Internet to store the images.

To place an image in the album, an image tool is needed to firstly upload the image. A convention image tool uses a single thread to upload the image to the album, i.e., after the uploading of a first image is completed, then a second image starts to be uploaded. Taking four images as example, referring to FIG. 1, the images are firstly pre-treated before uploading to fulfill the size requirement of the network album, the pre-treating also includes rotating the images to make the images upright, which takes some time, and the uploading takes time, too. As shown in FIG. 1, since only one image is pre-treated each at a time, and the next image will be pre-treated after the uploading of the formal image is completed, the total consuming time of dealing with four images is: S1+S1′+S2+S2′+S3+S3′+S4+S4′, where S1, S2, S3,and S4 are pretreatment time of the corresponding four images, and S1′, S2′, S3′, and S4′ are uploading time of the corresponding four images. Such a long time for uploading the images will result in a low utilization of network resources.

### SUMMARY OF THE INVENTION

Accordingly, it is necessary to provide an image uploading method which can improve the utilization of network resources and save image uploading time.

Additionally, it is necessary to provide an image uploading system which can improve the utilization of network resources and save image uploading time.

Additionally, it is necessary to provide a client which can improve the utilization of network resources and save image uploading time.

An image uploading method includes the step of:

acquiring an image uploading request;

labeling sequence information of images;

creating multiple threads according to the uploading request and the sequence information; and

uploading the images concurrently according to the created multiple threads.

In one embodiment, the step of creating multiple threads according to the uploading request and the sequence information includes:

creating a thread for each image to be uploaded when uploading the images according to a sequence of the sequence information, wherein the number of created threads is less than or equal to a preset thread threshold;

after the step of uploading the images concurrently according to the created multiple threads, the method further includes:

closing a thread when the uploading of the corresponding image is completed.

In one embodiment, after the step of uploading the images concurrently according to the created multiple threads, the method further includes:

sorting the images according to the sequence information.

In one embodiment, prior to the step of labeling sequence information of images, the method further includes:

acquiring information of an album;

determining if the number of the images to be uploaded exceeds the maximum number of images that can be stored in the album; if so, creating a new album and labeling the image with an object album where the image is to be uploaded; if not, labeling the image with an object album where the image is to be uploaded;

the step of uploading the images concurrently according to the created multiple threads comprises:

uploading the images concurrently to the corresponding object album according to the created multiple threads.

In one embodiment, the sequence information includes sort and uploading time of the images.

A client, includes one or more processors; and

memory having instructions stored thereon, the instructions, when executed by the one or more processors, cause the processors to perform operations comprising:

acquiring an image uploading request;

labeling sequence information of images;

creating multiple threads according to the uploading request and the sequence information; and

uploading the images concurrently according to the created multiple threads.

In one embodiment, the operation of creating multiple threads according to the uploading request and the sequence information is to create a thread for each image to be uploaded when uploading the images according to a sequence of the sequence information, wherein the number of created threads is less than or equal to a preset thread threshold;

the operations further include:

closing a thread when the uploading of the corresponding image is completed.

In one embodiment, the operations further include:

acquiring information of an album;

determining if the number of the images to be uploaded exceeds the maximum number of images that can be stored in the album;

wherein the operation of labeling sequence information of images is to label the image with an object album where the image is to be uploaded when a server determines that the number of the images to be uploaded exceeds the maximum number of images that can be stored in the album;

the operation of uploading the images concurrently according to the created multiple threads is to upload the images concurrently to the corresponding object album according to the created multiple threads.

In one embodiment, the sequence information includes sort and upload time of the images.

A computer storage medium for storing computer-executable instructions used for controlling an image uploading method, wherein the method includes:

acquiring an image uploading request;

labeling sequence information of images;

creating multiple threads according to the uploading request and the sequence information; and

uploading the images concurrently according to the created multiple threads

In one embodiment, the step of creating multiple threads according to the uploading request and the sequence information includes:

creating a thread for each image to be uploaded when uploading the images according to a sequence of the sequence information, wherein the number of created threads is less than or equal to a preset thread threshold;

after the step of uploading the images concurrently according to the created multiple threads, the method further includes:

closing a thread when the uploading of the corresponding image is completed.

In one embodiment, after the step of uploading the images concurrently according to the created multiple threads, the method further includes:

sorting the images according to the sequence information.

In one embodiment, prior to the step of labeling sequence information of images, the method further includes:

acquiring information of an album;

determining if the number of the images to be uploaded exceeds the maximum number of images that can be stored in the album; if so, creating a new album and labeling the image with an object album where the image is to be uploaded; if not, labeling the image with an object album where the image is to be uploaded;

the step of uploading the images concurrently according to the created multiple threads includes:

uploading the images concurrently to the corresponding object album according to the created multiple threads.

In one embodiment, the sequence information includes sort and uploading time of the images.

According to the forgoing image uploading method, system and client, the plurality of images are uploaded using multiply threads at the same time, it is not necessary to wait for the completion of the pre-treating and the uploading of the first image then to begin the pre-treating and the uploading of the second image, thus improving the utilization of the network resources and saving the overall time.

### BRIEF DESCRIPTION OF THE DRAWINGS

FIG. 1 is a schematic diagram showing a conventional process of uploading images.

FIG. 2 is a flow chart of an image uploading method according to an embodiment of the present invention.

FIG. 3 is a schematic diagram showing an uploading process of the image uploading method of the present invention.

FIG. 4 is a flow chart of an image uploading method according to another embodiment of the present invention.

FIG. 5 is a schematic diagram showing labeling sequence information of images according to an embodiment of the present invention.

FIG. 6 is a schematic block diagram of an image uploading system according to an embodiment of the present invention.

FIG. 7 is a schematic block diagram of an image uploading system according to another embodiment of the present invention.

FIG. 8 is a schematic block diagram of an image uploading system according to yet another embodiment of the present invention.

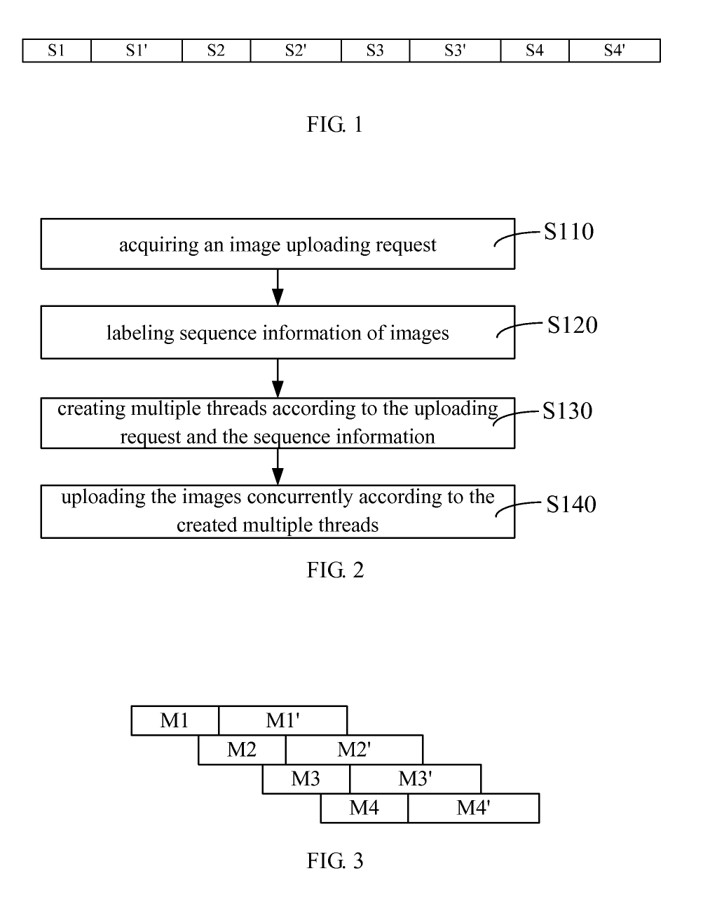

### DETAILED DESCRIPTION OF THE EMBODIMENTS

Reference will now be made to the drawings to describe, in detail, embodiments of the present image uploading method, system and client.

Referring to FIG. 2, according to an embodiment, an image uploading method includes the following steps:

Step S110, an image uploading request is acquired.

Specifically, a client, such as a network album program, is installed and run on a computer, such that an image uploading request triggered by the user is acquired by the client.

Step S120, sequence information of images are labeled.

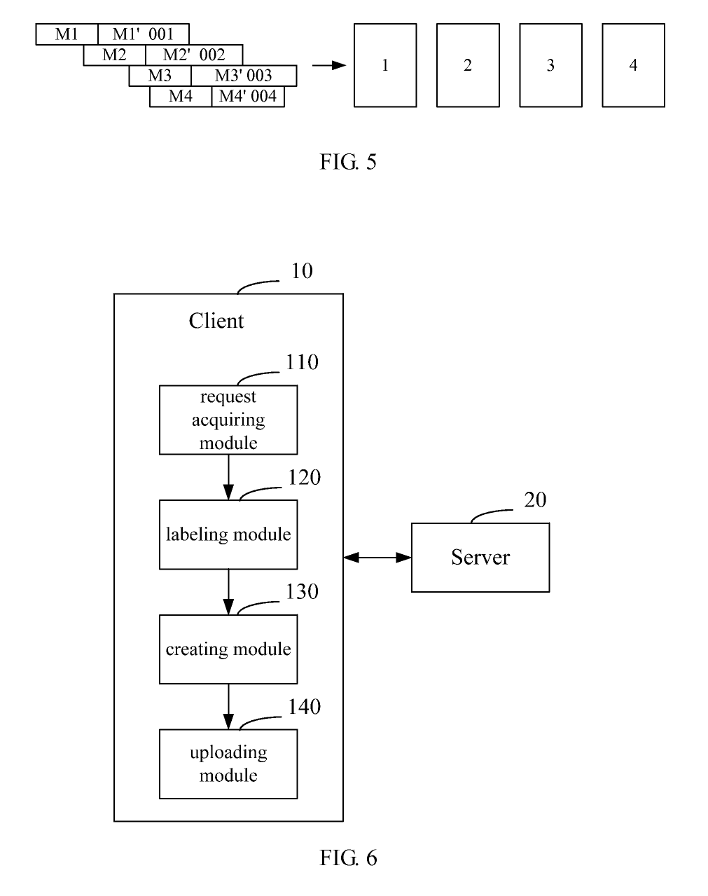

Specifically, the sequence information includes sort and uploading time of the images. The sort of the images refers to the order of the images before being uploaded. The uploading time refers to a specific time of uploading the images, such as 10000 ms. The sequence information of images is labeled as shown in FIG. 5, in which the sequence information of the first image is 001, the sequence information of the second image is 002, the sequence information of the third image is 003, the sequence information of the fourth image is 004.

Step S130, multiple threads are created according to the uploading request and the sequence information.

In one embodiment, the step S130 specifically includes: creating a thread for each image to be uploaded when uploading the images according to a sequence of the sequence information, wherein the number of created threads is less than or equal to a preset thread threshold. Specifically, the thread threshold can be configured to be four or five, which is not limited, according to the hardware, such as performing capability of the CPU.

Alternatively, a default number of threads are created, and the images are then assigned to idle threads according to the sort of the sequence information for uploading. The idle threads refer to those not performing uploading task.

Step S140, the images are uploaded concurrently according to the created multiple threads.

Specifically, uploading concurrently according to the multiple threads refers to upload the images concurrently according to the multiple threads. Before uploading, the images are pre-treated such that the size and the orientation of the images meet the uploading requirement.

After the step S140, the method further includes: closing a thread when the uploading of the corresponding image is completed.

For example, assuming the preset thread threshold is four, the number of images to be uploaded is ten. The ten images are labeled with sequence information and sorted as 001 to 010 according to the order of the sequence information. During the uploading, a first thread is created for uploading image 001, a second, a third, and a fourth threads are created for uploading image 002, 003, and 004, respectively. When the number of the threads reaches the preset thread threshold, no new thread will be created. When one of the four created threads is done uploading the image, the thread is closed, and a new thread is created for uploading image 005. The process repeats accordingly until all images are uploaded.

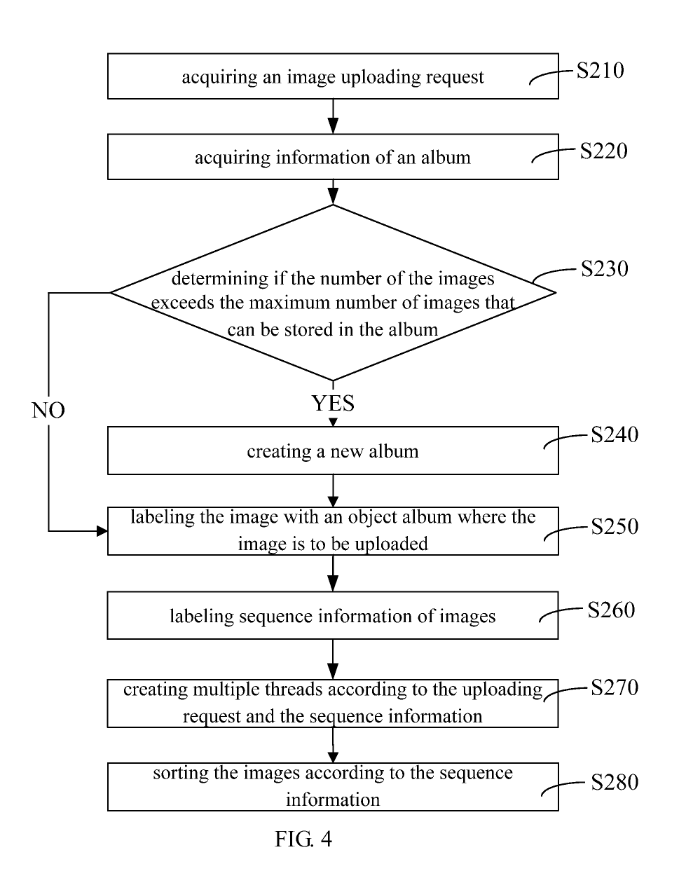

Referring to FIG. 3, M1, M2, M3, and M4 refer to pre-treating time of the four images, respectively; M1′, M2′, M3′, and M4′ refer to needed time for uploading of the four images. The total time of M2 and M2′ overlaps the total time of M1 and M1′, in other words, during the pre-treating and uploading of the first image, the pre-treating and the uploading of the second image has already begun. It is not necessary to wait for the completion of the pre-treating and the uploading of the first image then to begin the pre-treating and the uploading of the second image, therefore, the utilizations of computer processing resources and network resources are improved.

According to the forgoing image uploading method, the plurality of images are uploaded using multiply threads at the same time, it is not necessary to wait for the completion of the pre-treating and the uploading of the first image then to begin the pre-treating and the uploading of the second image, thus improving the utilization of the network resources and saving the overall time.

Referring to FIG. 4, according to an embodiment, an image uploading method includes the following steps:

Step S210, an image uploading request is acquired.

Step S220, an album information is acquired.

Specifically, the client sends a request to the server to acquire the album information, the server returns the album information to the client. The album information includes the maximum number of the images that can be stored in the album. In addition, the album information may also include the name of the album, the uniform resource locator address of the album, etc., which not limited thereto.

Step S230, determining if the number of the images to be uploaded exceeds the maximum number of images that can be stored in the album, if so, performing step S240; if not, performing step S250.

Specifically, the album is configured with a default maximum storage number of images. The maximum number of images that can be stored in the album is obtained by subtracting a number of the images already stored in the album from the default maximum storage number of the images. When the number of images to be uploaded exceeds the maximum number of images that can be stored in the album, a new album with the same name is created. The number of the new album can be created depending on the different circumstances. For example, assuming the default maximum storage number of images of the album A is 1000, and 400 images have be stored, then the maximum number of images that can be stored in the album A is 600. If there are 1000 images to be uploaded, then a new album B with the same name is created; and if there are 2500 images to be uploaded, then two new albums with the same name are created.

Step S240, a new album is created.

Specifically, the client sends a creating request to the server, and the server creates the album according to the creating request. During the uploading of the creating request, if the network is jammed or the sending of request is timeout, the creating request is then resent.

Step S250, the image is labeled with an object album where the image is to be uploaded.

Specifically, assuming two albums exist by creating the new album, each image should be labeled with which album (object album) it is to be uploaded. Assuming there are 1000 images which are labeled with number 1 to 1000 according to the orders, the object album for the images labeled with number 1 to 600 is album A, and the object album for the images labeled with number 601 to 1000 is album B.

Step S260, sequence information of images are labeled.

Specifically, the sequence information includes sort and uploading time of the images. The sort of the images refers to the order of the images before being uploaded. The uploading time refers to a specific time of uploading the images, such as 10000 ms. The sequence information of images is labeled as shown in FIG. 5, in which the sequence information of the first image is 001, the sequence information of the second image is 002, the sequence information of the third image is 003, the sequence information of the fourth image is 004.

Step S270, multiple threads are created according to the uploading request and the sequence information.

Step S280, the images are sorted according to the sequence information.

Referring to FIG. 5, specifically, the four images are arranged in sequence consistent with the sequence arranged before uploading.

For example, ten images are firstly uploaded with a sequence from 1 to 10, and five images are secondly uploaded with a sequence from 1 to 5. The first uploading time refers to server's time, i.e. 10000. Accordingly, the sequence of the firstly uploaded ten images is from 10001 to 10010. The second first uploading time refers to server's time, i.e. 50000. Accordingly, the sequence of the secondly uploaded five images is from 50001 to 50005.

Additionally, during the uploading, it is to be determined if the number of images already being uploaded exceeds the default maximum storage number of images, if so, a new album is created. If more than one thread detect that the default maximum storage number of images is reached, then more than one album will be created.

Referring to FIG. 6, in one embodiment, an image uploading system includes a client 10 and a server 20. The client 10 includes a request acquiring module 110, a labeling module 120, a creating module 130, and an uploading module 140.

The request acquiring module 110 is configured to acquire an image uploading request.

The labeling module 120 is configured to label sequence information of images.

Specifically, the sequence information includes sort and uploading time of the images. The sort of the images refers to the order of the images before being uploaded. The uploading time refers to a specific time of uploading the images, such as 10000 ms. The sequence information of images is labeled as shown in FIG. 5, in which the sequence information of the first image is 001, the sequence information of the second image is 002, the sequence information of the third image is 003, the sequence information of the fourth image is 004.

The creating module 130 is configured to create multiple threads according to the uploading request and the sequence information.

In one embodiment, the creating module 130 is also configured to create a thread for each image to be uploaded when uploading the images according to a sequence of the sequence information, wherein the number of created threads is less than or equal to a preset thread threshold.

Specifically, the thread threshold is configured to be four or five, which is not limited, according to the hardware, such as performing capability of the CPU.

Alternatively, the creating module 130 is configured to create a default number of threads. The uploading module 140 assigns the images to idle threads according to the created default number of threads and the sort of the sequence information for uploading. The idle threads refer to those not performing uploading task.

The uploading module 140 is configured to upload the images concurrently according to the created multiple threads.

Specifically, uploading concurrently according to the multiple threads refers to upload the images concurrently according to the multiple threads. Before uploading, the images are pre-treated such that the size and the orientation of the images meet the uploading requirement, which is shown in FIG. 3.

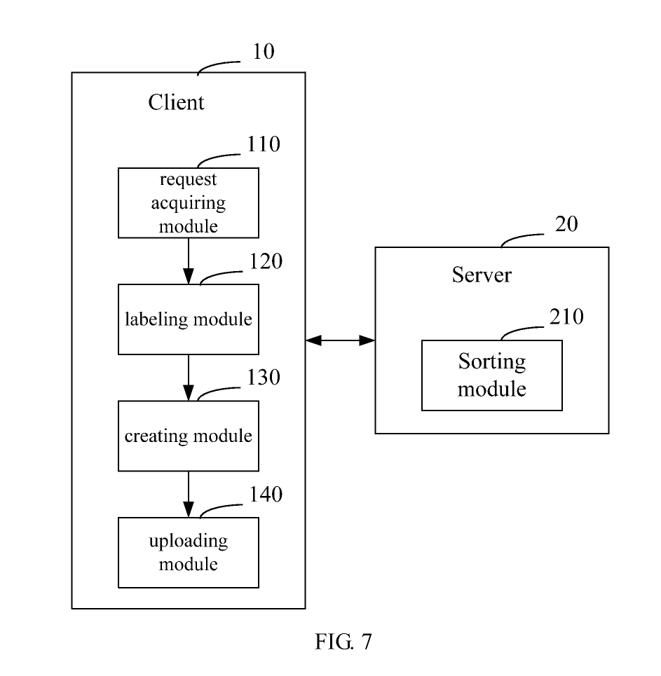

Referring to FIG. 7, in one embodiment, the server 20 includes a sorting module 210.

The sorting module 210 is configured to sort the images according to the sequence information. Specifically, four images are arranged in sequence consistent with the sequence arranged before uploading.

For example, ten images are firstly uploaded with a sequence from 1 to 10, and five images are secondly uploaded with a sequence from 1 to 5. The first uploading time refers to server's time, i.e. 10000. Accordingly, the sequence of the firstly uploaded ten images is from 10001 to 10010. The second first uploading time refers to server's time, i.e. 50000. Accordingly, the sequence of the secondly uploaded five images is from 50001 to 50005.

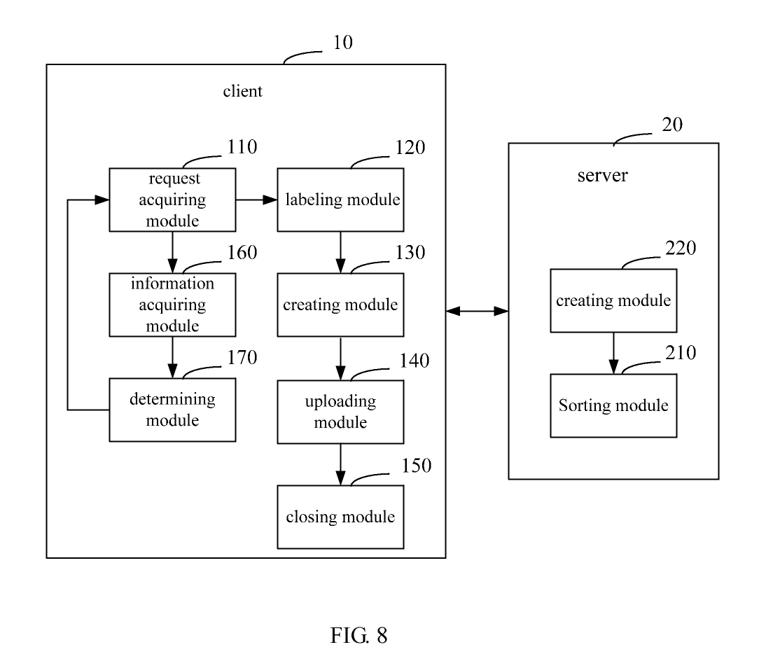

Referring to FIG. 8, in one embodiment, in addition to the request acquiring module 110, the labeling module 120, the creating module 130, and the uploading module 140, the client 10 further includes a closing module 150, an information acquiring module 160, and a determining module 170. In addition to the sorting module 210, the server further includes a creating module 220.

The closing module 150 is configured to close the thread when the uploading of the corresponding image is completed.

For example, assuming the preset thread threshold is four, and the number of images to be uploaded is ten. The ten images are labeled with sequence information and sorted as 001 to 010 according to the order of the sequence information. During the uploading, a first thread is created for uploading image 001, a second, a third, and a fourth threads are created for uploading image 002, 003, and 004, respectively. When the number of the threads reaches the preset thread threshold, no new thread will be created. When one of the four created threads is done uploading the image, the thread is closed, and a new thread is created for uploading image 005. The process repeats accordingly until all images are uploaded.

The information acquiring module 160 is configured to acquire the album information. The album information includes the maximum number of the images that can be stored in the album. In addition, the album information may also include the name of the album, the uniform resource locator address of the album, etc., which not limited thereto.

The determining module 170 is configured to determining if the number of the images to be uploaded exceeds the maximum number of images that can be stored in the album.

Specifically, the album is configured with a default maximum storage number of images. The maximum number of images that can be stored in the album is obtained by subtracting a number of the images already stored in the album from the default maximum storage number of the images.

The request acquiring module 110 is further configured to acquire an album creating request when the number of images to be uploaded exceeds the maximum number of images that can be stored in the album.

The uploading module 140 is further configured to upload an album creating request. Specifically, the album creating request is sent to the server 20 by the uploading module 140, and the creating module 220 of the server 20 creates a new album.

The creating module 220 is configured to create the new album according to the album creating request.

When the number of images to be uploaded exceeds the maximum number of images that can be stored in the album, the creating module 220 creates a new album with the same name. The number of the new album can be created depending on the different circumstances. For example, assuming the default maximum storage number of images of the album A is 1000, and 400 images have be stored, then the maximum number of images that can be stored in the album A is 600. If there are 1000 images to be uploaded, then a new album B with the same name is created; and if there are 2500 images to be uploaded, then two new albums with the same name are created.

The labeling module 120 is configured to label the image with an object album where the image is to be uploaded. Specifically, assuming two albums exist by creating the new album, each image should be labeled with which album (object album) it is to be uploaded. Assuming there are 1000 images which are labeled with number 1 to 1000 according to the orders, the object album for the images labeled with number 1 to 600 is album A, and the object album for the images labeled with number 601 to 1000 is album B.

The uploading module 140 is further configured to upload the images concurrently to the corresponding object album via the created multiple threads according to the uploading request.

Furthermore, a client is provided including: a request acquiring module, an uploading module, a labeling module, an information acquiring module, and a determining module. The modules above have the same functions as the corresponding modules in the client 10 of the image uploading system, which will not be further described. Moreover, the labeling module is configured to label the image with an object album where the image is to be uploaded when a server determines that the number of the images to be uploaded exceeds the maximum number of images that can be stored in the album.

In the forgoing image uploading method, system and client, multiply threads are used to upload the images concurrently, it is not necessary to wait for the completion of the pre-treating and the uploading of the first image then to begin the pre-treating and the uploading of the second image, thus improving the utilization of the network resources and saving the overall time.

In addition, before uploading the images, the number of images is determined whether it exceeds the maximum number of images that can be stored in the album, and new album is created when the number of images exceeds the maximum number, thus avoiding the problem of wasting resources that more than one album is create when multiply threads detect the album is full during the uploading process. Furthermore, labeling the images with the object album before uploading can avoiding storing error. Moreover, the sequence information of the images is labeled before uploading, thus that the uploaded images can be sort by the server according to the label, thus avoiding adjustment operation.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

Although the present invention has been described with reference to the embodiments thereof and the best modes for carrying out the present invention, it is apparent to those skilled in the art that a variety of modifications and changes may be made without departing from the scope of the present invention, which is intended to be defined by the appended claims.

What is claimed is:

1. An image uploading method, comprising the step of:
acquiring an image uploading request;
labeling sequence information of images;
creating multiple threads according to the uploading request and the sequence information; and
uploading the images concurrently according to the created multiple threads.

2. The method according to claim 1, wherein the step of creating multiple threads according to the uploading request and the sequence information comprises:
creating a thread for each image to be uploaded when uploading the images according to a sequence of the sequence information, wherein the number of created threads is less than or equal to a preset thread threshold; and
after the step of uploading the images concurrently according to the created multiple threads, the method further comprises:
closing a thread when the uploading of the corresponding image is completed.

3. The method according to claim 1, wherein after the step of uploading the images concurrently according to the created multiple threads, the method further comprises: sorting the images according to the sequence information.

4. The method according to claim 1, wherein prior to the step of labeling sequence information of images, the method further comprises:
acquiring information of an album; and
determining if the number of the images to be uploaded exceeds the maximum number of images that can be stored in the album; if so, creating a new album and labeling the image with an object album where the image is to be uploaded; if not, labeling the image with an object album where the image is to be uploaded; and
wherein the step of uploading the images concurrently according to the created multiple threads comprises:
uploading the images concurrently to the corresponding object album according to the created multiple threads.

5. The method according to claim 1, wherein the sequence information comprises sort and uploading time of the images.

6. A client, comprising:
one or more processors; and
memory having instructions stored thereon, the instructions, when executed by the one or more processors, cause the one or more processors to perform operations comprising:
acquiring an image uploading request;
labeling sequence information of images;
creating multiple threads according to the uploading request and the sequence information; and
uploading the images concurrently according to the created multiple threads.

7. The client according to claim 6, wherein the operation of creating multiple threads according to the uploading request and the sequence information is to create a thread for each image to be uploaded when uploading the images according to a sequence of the sequence information, wherein the number of created threads is less than or equal to a preset thread threshold; and
wherein the operations further comprise:
closing a thread when the uploading of the corresponding image is completed.

8. The client according to claim 6, wherein the operations further comprise:
acquiring information of an album; and
determining if the number of the images to be uploaded exceeds the maximum number of images that can be stored in the album;
wherein the operation of labeling sequence information of images is to label the image with an object album where the image is to be uploaded when a server determines that the number of the images to be uploaded exceeds the maximum number of images that can be stored in the album; and
wherein the operation of uploading the images concurrently according to the created multiple threads is to upload the images concurrently to the corresponding object album according to the created multiple threads.

9. The client according to claim 6, wherein the sequence information comprises sort and upload time of the images.

10. A computer storage medium for storing computer-executable instructions used for controlling an image uploading method, wherein the method comprises:
acquiring an image uploading request;
labeling sequence information of images;
creating multiple threads according to the uploading request and the sequence information; and
uploading the images concurrently according to the created multiple threads.

11. The computer storage medium according to claim 10, wherein the step of creating multiple threads according to the uploading request and the sequence information comprises:
creating a thread for each image to be uploaded when uploading the images according to a sequence of the sequence information, wherein the number of created threads is less than or equal to a preset thread threshold; and
after the step of uploading the images concurrently according to the created multiple threads, the method further comprises:
closing a thread when the uploading of the corresponding image is completed.

12. The computer storage medium according to claim 10, wherein after the step of uploading the images concurrently according to the created multiple threads, the method further comprises:
sorting the images according to the sequence information.

13. The computer storage medium according to claim 10, wherein prior to the step of labeling sequence information of images, the method further comprises:
acquiring information of an album; and
determining if the number of the images to be uploaded exceeds the maximum number of images that can be stored in the album; if so, creating a new album and labeling the image with an object album where the image is to be uploaded; if not, labeling the image with an object album where the image is to be uploaded; and
the step of uploading the images concurrently according to the created multiple threads comprises:
uploading the images concurrently to the corresponding object album according to the created multiple threads.

14. The computer storage medium according to claim 10, wherein the sequence information comprises sort and uploading time of the images.
